(19) United States
(12) Patent Application Publication
(10) Pub. No.: US 2007/0040050 A1
(43) Pub. Date: Feb. 22, 2007

(54) Spray device for spraying liquids, and nozzle holder

(76) Inventor: Wolf-Dieter Wichmann, Neetzow (DE)

Correspondence Address: FLYNN THIEL BOUTELL & TANIS, P.C., 2026 RAMBLING ROAD, KALAMAZOO, MI, 49008-1631, US

(21) Appl. No.: 10/579,258

(22) PCT Filed: Nov. 13, 2004
(86) PCT No.: PCT/EP04/12880

§ 371 Date: May 11, 2006

(30) Foreign Application Priority Data
Nov. 18, 2003 (DE) 103 53 789.9

(51) Int. Cl. B05B 7/12

(52) U.S. Cl. 239/413; 239/417.5

(57) ABSTRACT

The invention relates to a spray device for spraying liquids, especially for agricultural purposes, said spray device comprising a carrier liquid tank, a carrier liquid pump, a plurality of spray nozzles, associated nozzle holders for connecting the spray nozzles to a carrier liquid line, at least one active ingredient tank, and a plurality of dosing pumps that are used to transport active ingredients and can be connected to the active ingredient tank. According to the invention, at least one dosing pump is associated with each nozzle holder by means of a fluid connection. The inventive spray device can be used, for example, to spray specific areas of a field with active ingredients.

The invention relates to a sprayer for spraying liquids, particularly for agricultural purposes, with a carrier liquid tank, a carrier liquid pump, several spraying nozzles and associated nozzle holders for linking the spraying nozzles with a carrier liquid line, at least one active ingredient tank and several metering pumps for delivering the active ingredient connectable to the active ingredient tank. The invention also relates to a nozzle holder for a sprayer according to the invention.

German patent DE 298 722 A5 discloses an agricultural sprayer, in which an active ingredient from an active ingredient tank is fed in directly upstream of the branching into partial widths. The active ingredient is conveyed in a ring conduit containing a metering pump. Starting from said ring conduit, the individual infeed points are supplied upstream of the branching into partial widths.

German specification DE 199 04 102 A1 discloses an agricultural sprayer, in which a metering pump meters in an active ingredient upstream of a carrier liquid pump. If several active ingredients are metered in, several such metering pumps are provided. The metered in active ingredient quantity is controlled by a control mechanism for the control of the metering pumps.

International patent publication WO 96/35876 discloses a hydraulically controlled diaphragm pump.

The translation of European patent DE 38 79 446 T2 discloses an agricultural sprayer, in which an active ingredient is fed into a carrier liquid line upstream of a mixing chamber. Downstream of the mixing chamber branching to the individual spraying nozzles takes place. The sprayer has a calibrating device in order to set a metered in active ingredient quantity.

German patent DE 39 08 963 C2 discloses an agricultural sprayer, in which active ingredient is supplied by a metering pump to a carrier liquid upstream of the branching into individual partial widths. The metering pumps are constructed as reciprocating pumps, whose displacement per stroke is constant and individually adjustable prior to the starting of a run. The metering pumps are driven by means of electromagnetic converters with a variable stroke frequency as a function of the instantaneous running speed.

The invention aims at providing a sprayer and a nozzle holder through which it is possible to modify the active ingredient concentration with a negligible dead or idle time.

To this end the invention discloses a sprayer for spraying liquids, particularly for agricultural purposes, having a carrier liquid tank, a carrier liquid pump, several spraying nozzles and associated nozzle holders for connecting the spraying nozzles to a carrier liquid line, at least one active ingredient tank and several metering pumps for delivering the active ingredient and connectable to said active ingredient tank, in which with each nozzle holder is associated at least one metering pump, which is in flow connection with the nozzle holder.

In that at least one metering pump is associated with each nozzle holder, the active ingredient can be fed in directly upstream of the spraying nozzles. On changing the active ingredient concentration or on changing the active ingredient, this leads to only negligible idle times before the modified active ingredient concentration reaches the spraying nozzle. The infeed at the nozzle holder offers the advantage that the carrier liquid line can be kept free from active ingredient. On arranging the spraying nozzles and metering pumps in several partial widths, it is possible to separately implement a change to the active ingredient concentration on the basis of the partial widths. There is also the advantage that there are no residual quantities of active ingredient mixed with carrier liquid. If several active ingredients are simultaneously used, due to the short residence or hold-up times between the metering pumps and spraying nozzles, chemical incompatibilities between different active ingredients have virtually no importance.

According to a further development of the invention on each nozzle holder is provided at least one metering pump.

This permits particularly short paths and a compact construction. This further minimizes idle times on changing the active ingredient concentration.

According to a further development of the invention a mixing chamber is provided on each nozzle holder. Thus, even in the case of very low concentrations and/or several active ingredients, there is a good, thorough mixing, even over the short distance from the infeed point of the active ingredients to the spraying nozzles.

According to a further development of the invention a control unit is provided, which calculates the active ingredient quantity to be metered in in control pulses, the metering pumps have a clearly defined delivery per working stroke and can be driven by means of corresponding control pulses.

This permits a precise metering of the active ingredient, accompanied by a simple control. There is no need for a flow rate meter in the active ingredient lines, because the metered in active ingredient quantity results from the number of pulses in conjunction with the defined delivery per working stroke of the metering pumps.

All identically constructed metering pumps on the different nozzle holders advantageously have precisely the same delivery per pulse.

According to a further development of the invention the control unit determines the number of control pulses as a function of a predetermined set value for an active ingredient concentration and the carrier liquid quantity instantaneously delivered by the carrier liquid pump.

Thus, it is possible to retain the control system for the carrier liquid quantity, e.g. as a function of the travel speed present in conventional field sprayers, without the control unit having to know the actual travel speed. Instead the output signal of the in any case present flow rate meter for the carrier liquid is supplied to the control unit which then, by means of a predetermined active ingredient concentration, generates control pulses for the metering pumps.

According to a further development of the invention the metering pumps can be driven by hydraulic pulses.

In this way, even with limited electric power, numerous metering pumps can be driven without difficulty on a mobile field sprayer with the possibly necessary high hydraulic capacities. The electrical energy expenditure is low, because only the control means is operated electrically or electronically, whereas the actual drive power is produced hydraulically.

The invention also aims at providing a sprayer for spraying liquids, in which active ingredient still present in the active ingredient lines after ending spraying can be returned to an active ingredient tank.

To this end, according to the invention a sprayer for spraying liquids is equipped with a carrier liquid tank, a carrier liquid pump, several spraying nozzles, at least one active ingredient tank and several metering pumps connectable by at least one active ingredient supply line to the active ingredient tank, where a compressed air connection is provided on the active ingredient supply line in order to force active ingredient into the active ingredient tank during a return operation.

Due to the fact that the active ingredient is forced back by compressed air into the active ingredient tank, it does not come into contact with the carrier liquid and can consequently be used again during the next spraying operation. However, the active ingredient lines are freed from the active ingredient to such an extent that only active ingredient residues adhering to the line walls are left behind.

According to a further development of the invention several nozzle holders with metering pumps are connected in series to the active ingredient supply line and the compressed air connection is provided downstream of the final metering pump in the active ingredient supply direction. Advantageously the several nozzle holders are arranged in partial widths, several of the latter being provided. With each partial width is associated a partial width active ingredient supply line with in each case one compressed air connection.

Thus, even highly branched active ingredient line systems can be largely freed from active ingredient at the end of spraying. The contaminated washing water quantities occurring during a possibly following washing operation are consequently small or only slightly contaminated with active ingredient. Moreover the active ingredient losses can be kept very low.

The problem of the invention is also solved by a nozzle holder for the sprayer according to the invention and which has a mixing chamber and/or a metering pump.

Further features and advantages of the invention can be gathered from the following description of a preferred embodiment of the invention in conjunction with the drawings, wherein show:

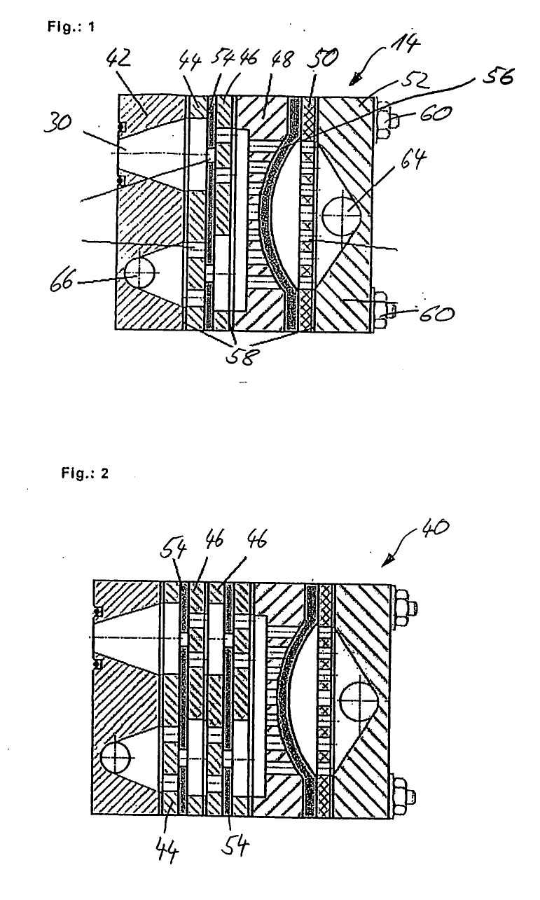

FIG. 1 A sectional view of a metering pump for the inventive sprayer according to a first embodiment.

FIG. 2 A sectional view of a metering pump according to a second embodiment.

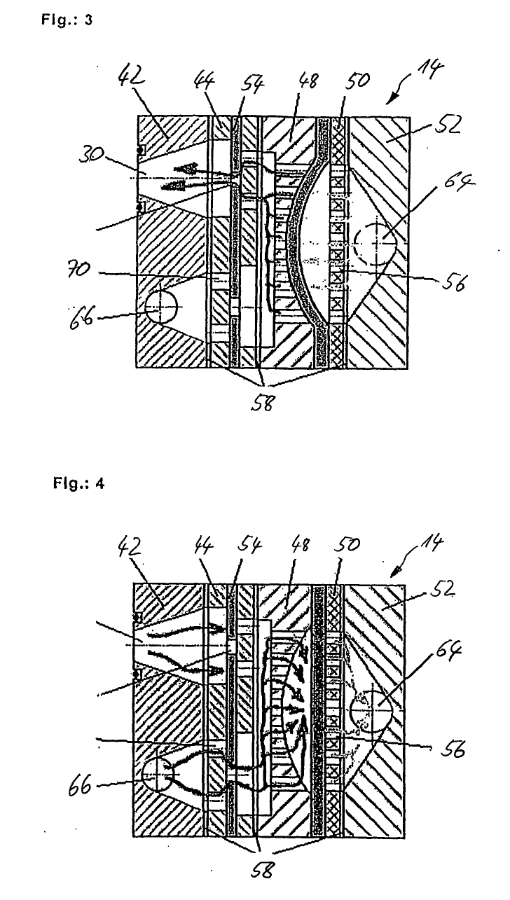

FIG. 3 A view of the metering pump of FIG. 1 in a working or pressure cycle.

FIG. 4 The metering pump of FIG. 1 in a rest or vacuum cycle.

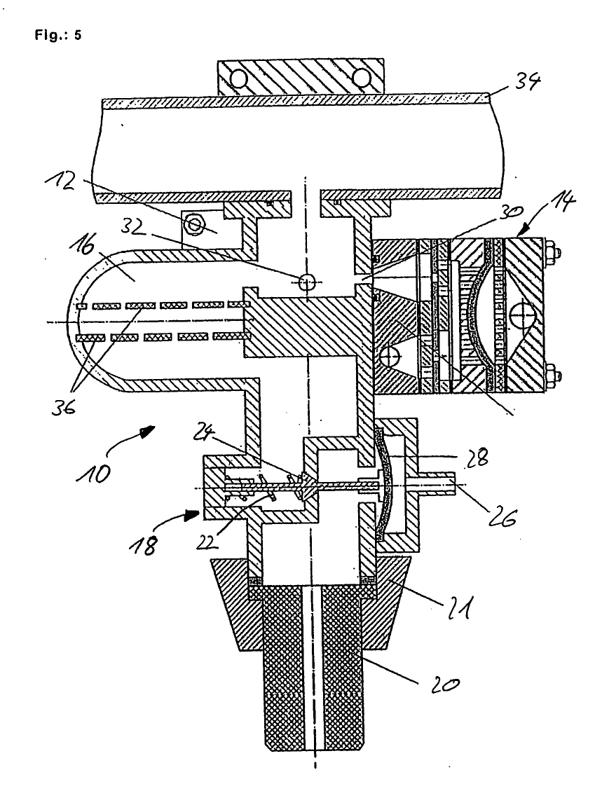

FIG. 5 A sectional view of an inventive nozzle holder with mixing chamber and metering pump for direct metering.

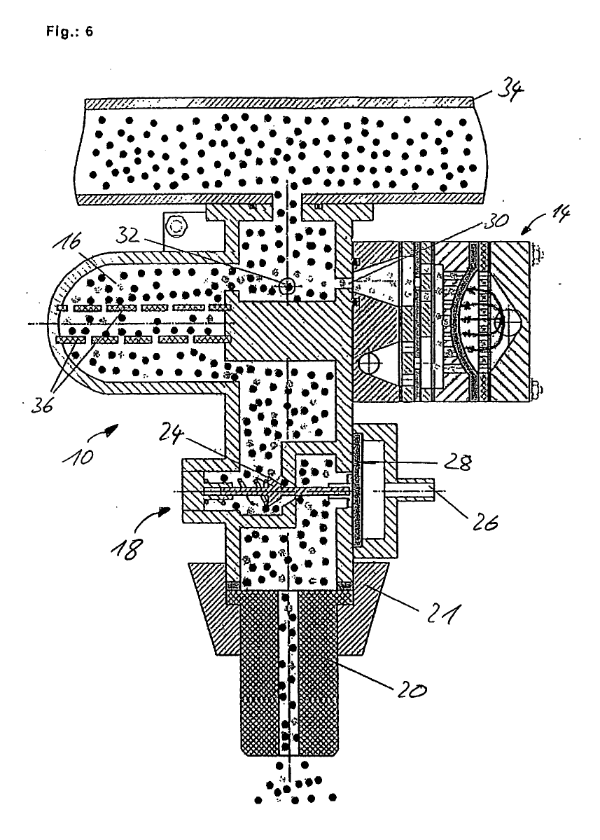

FIG. 6 The nozzle holder of FIG. 5 during spraying operation.

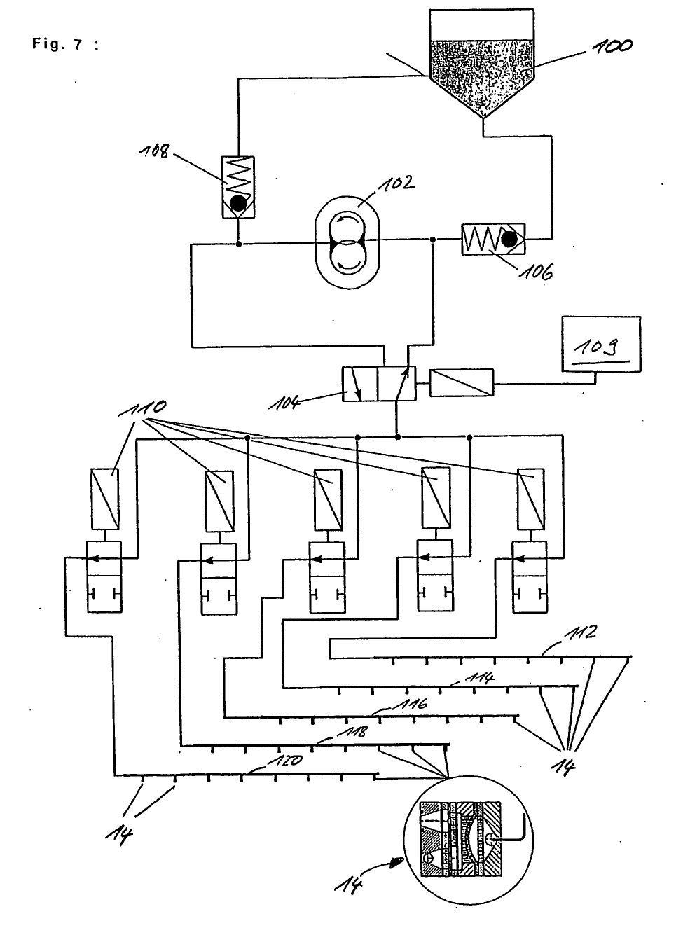

FIG. 7 A view of a hydraulic drive system for driving the metering pumps with partial width disconnection.

FIG. 8 A view of a drive system for the metering pumps according to a further embodiment for different metering levels at the partial widths.

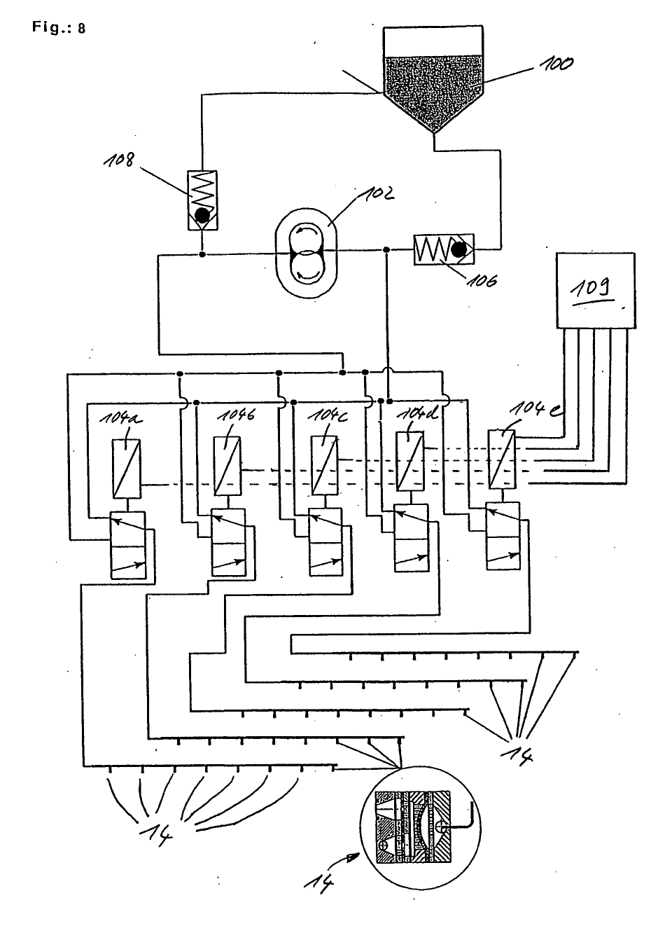

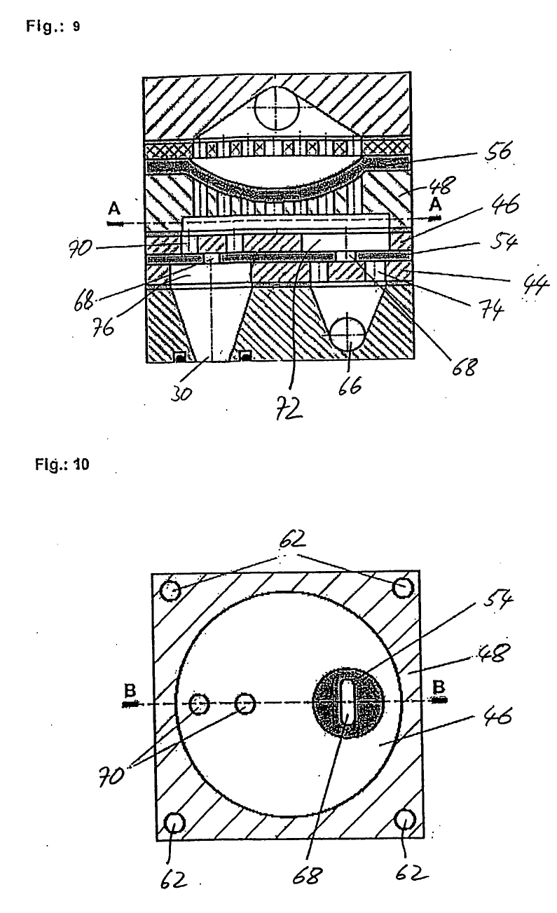

FIG. 9 A sectional view of a metering pump similar to FIG. 1.

FIG. 10 A sectional view along line A-A of FIG. 9.

FIG. 11 A sectional view along line B-B of FIG. 10 during a suction stroke.

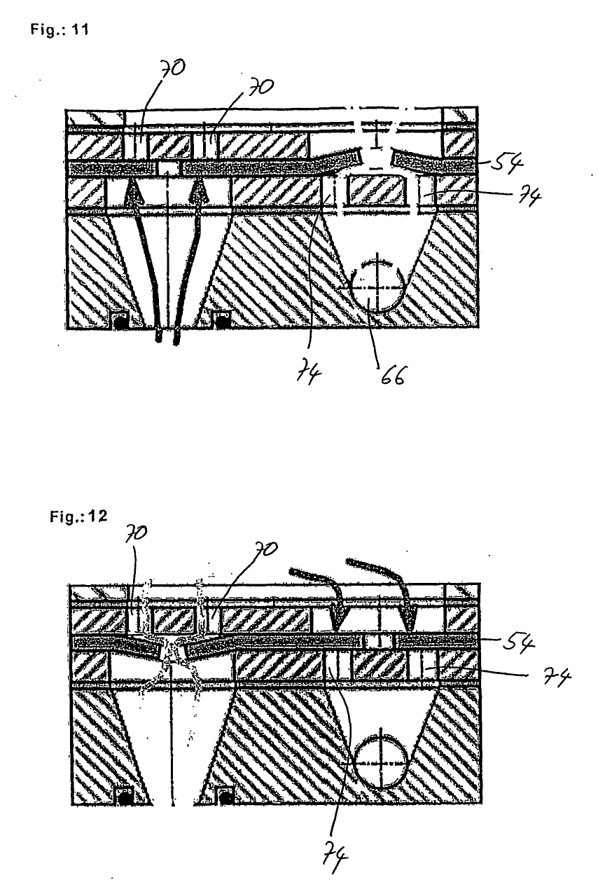

FIG. 12 A sectional view along line B-B of FIG. 10 in a feed stroke.

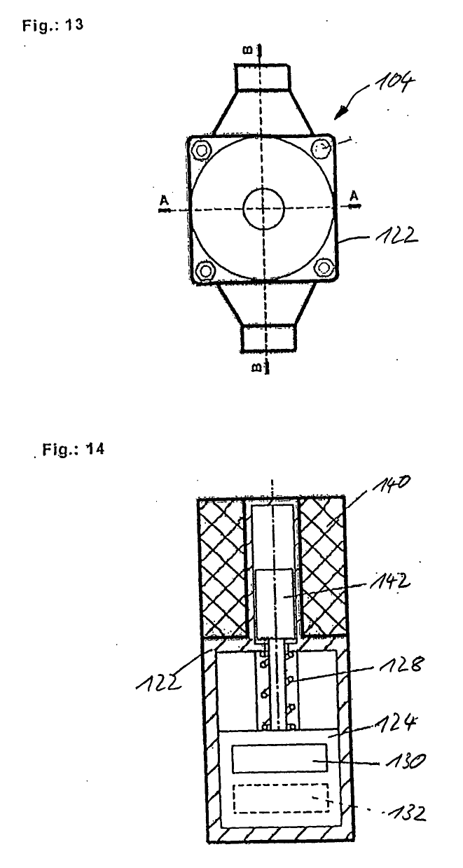

FIG. 13 A plan view of an electrohydraulic flat slide pulse valve in the hydraulic drive system of FIGS. 7 and 8.

FIG. 14 A sectional view along line A-A of FIG. 13 in a rest or vacuum stroke.

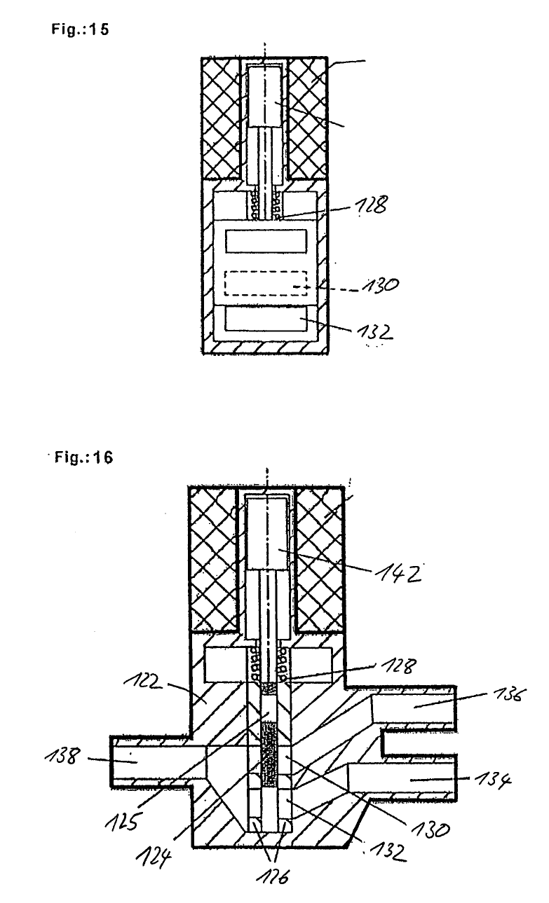

FIG. 15 A sectional view along line A-A of FIG. 13 in a pulse or pressure stroke.

FIG. 16 A sectional view along line B-B of FIG. 13 in a pulse or pressure stroke.

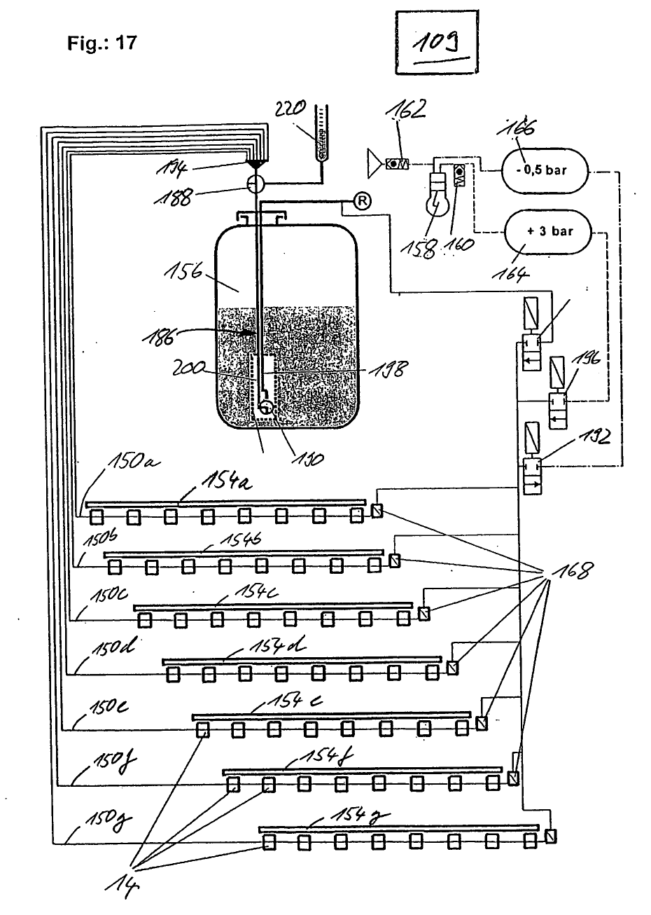

FIG. 17 A view of an active ingredient supply system for the inventive sprayer.

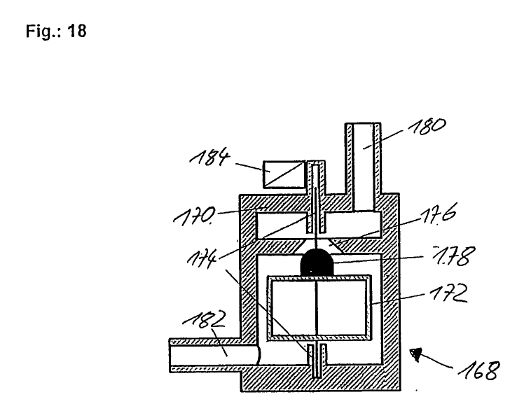

FIG. 18 A sectional view of a float valve in the active ingredient supply system of FIG. 17.

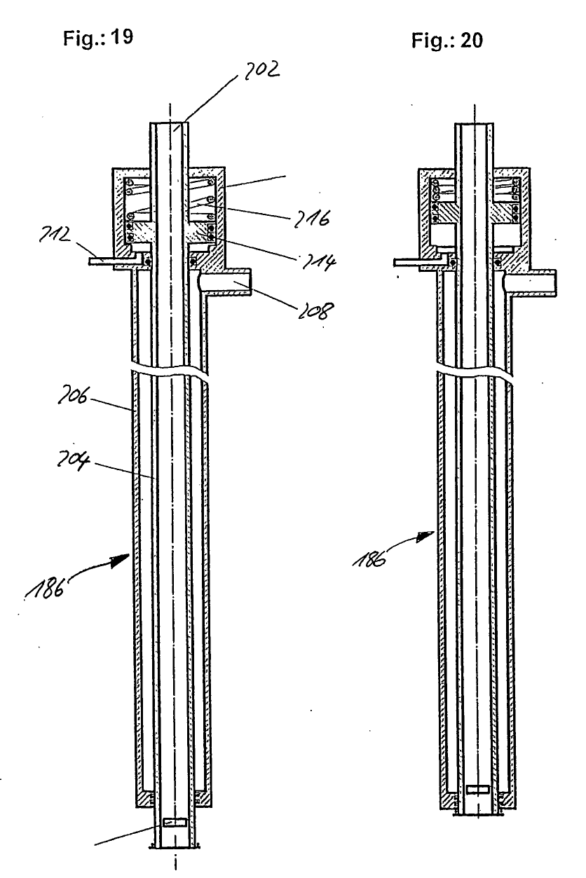

FIG. 19 A sectional view of a hydraulically operated suction lance with washing function in the active ingredient supply system of FIG. 17, during suction.

FIG. 20 The suction lance of FIG. 19, during washing.

FIG. 21 A sectional view of a diaphragm-sealed reciprocating metering pump for an inventive sprayer.

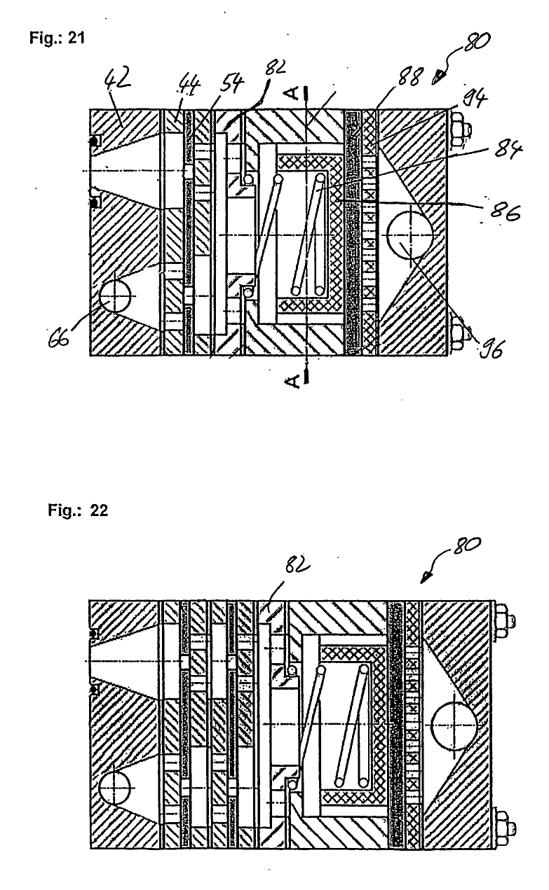

FIG. 22 A sectional view of a diaphragm-sealed reciprocating metering pump according to another embodiment.

FIG. 23 A view of the reciprocating metering pump of FIG. 21 in a working stroke.

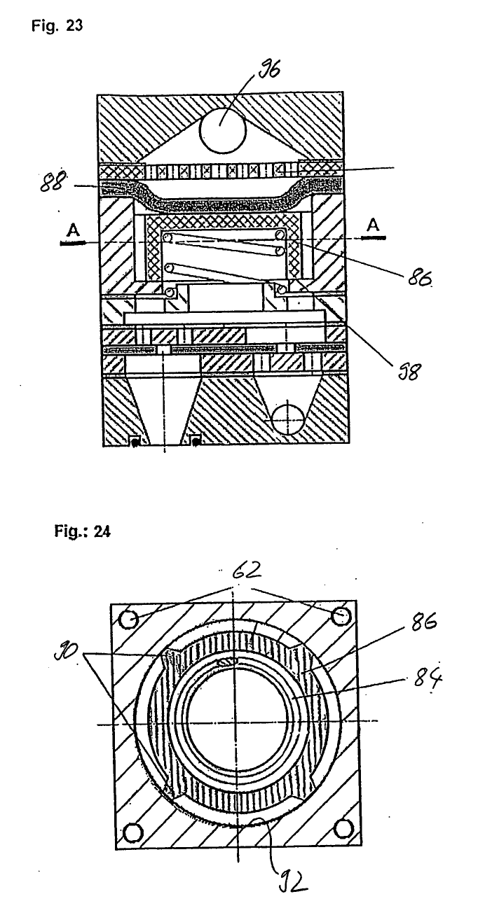

FIG. 24 A sectional view along lines A-A of FIGS. 21 and 23.

The invention provides a crop protection sprayer with direct metering of the active ingredients at the nozzle holders by hydraulically driven metering pumps.

Unlike in the prior art, in the case of the sprayer according to the invention the active ingredients are not added to the carrier liquid water in the spray tank. Except during the application of liquid fertilizers and salts, the spray tank is only used as a clean water storage tank. The desired active ingredient concentration is generated directly at each nozzle holder in order to avoid a forward delivery of residual amounts and large quantities of contaminated liquid into the storage tank. The mixing ratio between water and active ingredient is generated by a computer, which permits a connection and disconnection of active ingredients and a change to their concentration during the spraying process.

According to the invention there are several metering pumps at each nozzle holder. These metering pumps are driven hydraulically and per diaphragm stroke deliver a precisely defined, liquid active ingredient quantity. With the association of a precisely identical delivery per stroke and metering pump, which is located at the nozzle holder, a computer is able to define the liquid quantities to be delivered in pulses. Based on predetermined set values and the measured, instantaneously delivered water quantity a computer is able to generate the necessary pulse frequency for producing a predetermined active ingredient concentration.

The electric computer pulses are converted by an independent hydraulic system into hydraulic pulses, which drive the diaphragms in the metering pumps of the nozzle holders. The homogeneous distribution and mixing of the not continuously supplied active ingredients with the water is ensured by a mixing chamber, which is part of each nozzle holder.

The procedure or inventive sprayer can be used in all sectors of agriculture, horticulture and fruit culture for crop protection purposes. The sprayer can also be used in all sectors where it is necessary to have changing mixing ratios of different liquids as a consequence of varying predetermined set values or flow quantities.

According to the prior art, before the start of spraying mixing takes place between water and active ingredients in the storage or spray tank of the crop protection sprayer with the aid of infeed and stirring devices. As the spraying mixture quantity required for a particular treatment can only be approximately determined, generally more spraying mixture is mixed than is ultimately required. The resulting residual quantities must be diluted until they are inactive and then additionally applied to the field. This wastes water, active ingredient and labour time and unnecessarily prejudices the environment. In order at the start of spraying to have in stock the requisite concentration at the nozzles, additional forward feeding and rinsing systems are operated. A connecting in or disconnection of active ingredients is either impossible, or is only possible through the use of additional complicated means for a partial area-specific treatment. A change to the concentration of individual active ingredients during the spraying process is impossible with this procedure. If for atmospheric or technical reasons it is necessary to interrupt spraying, mixed spraying mixture remains in the spray tank. As a result of possible leaks, this constitutes a risk for the environment and in certain circumstances has a disadvantageous influence on the effectiveness of the chemicals. Since during the spraying process and often on the way to the field the entire spray tank and large parts of the fittings and pipes are contaminated with the active ingredients, if there is damage or a breakdown to the sprayer, there are incalculable environmental risks.

As opposed to this, according to the present invention only water is carried along in the storage tank and the at present up to three active ingredients are only added directly at the nozzle holders during the spraying process in the field.

For this purpose on the nozzle holders are provided active ingredient pumps, referred to in future as metering pumps, which during a working cycle or a pulse always deliver a precisely identical liquid quantity. This identical delivery per pulse for each nozzle makes it possible to define the supply of active ingredients in accordance with the predetermined set values in pulses and to generate the necessary pulse frequency using a computer.

The determination of the instantaneously delivered water quantity by the flow rate meter which is already present on a conventional sprayer and necessary for pressure regulation purposes and the inputted predetermined set values make it possible for a computer to calculate precise, instantaneous mixing ratios and define the same in pulse frequencies. As a result the following advantages are obtained compared with the prior art procedure with active ingredient/water mixing in the spray tank.

The active ingredients are admittedly carried in highly concentrated form on the sprayer, but in much smaller quantities than in the prior art. This provides the prerequisite for additional safety means, such as collecting troughs or the like for leaks, which in an emergency are able to completely collect all escaping chemical quantities and therefore avoid environmental damage. This is impossible with the presently transported contaminated liquid quantities.

Residual quantities are significantly reduced and the disposal thereof on the field is greatly simplified. Residual quantities only arise during the washing or rinsing of line systems for the supply of active ingredients during an active ingredient change.

The invention greatly simplifies the operation of the field sprayer. The user inputs to the computer the set values for the mixing ratios between water and active ingredient, hereinafter called concentration, and the computer produces this concentration instantaneously during working. Diverging from the prior art, this makes it unnecessary for the user to carry out prior calculations of quantities to be used with the associated risk of error. This also greatly reduces contact between the user and chemicals.

The invention makes it possible during the spraying process to connect in and disconnect active ingredients and to modify the concentration thereof in the water in accordance with predetermined user values and this can optionally be based on partial widths.

In the case of large tank volumes, the invention ensures a precise metering of active ingredients with small quantities used and whilst avoiding distribution risks as a result of an inadequate stirring capacity or unfavourable tank shapes.

The invention is based on a field sprayer with identical nozzle pipes, nozzles, water pressure production and water control, such as are presently conventional in crop protection. Diverging from the prior art with the spraying mixture mixed in the spray tank, there are novel systems and components.

A. Computer for inputting preset values and generating the necessary pulse frequencies.

B. Nozzle holder with metering pumps and countercurrent mixing chambers.

C. Diaphragm metering pumps with slot diaphragm valves.

D. Optionally there are diaphragm-sealed reciprocating metering pumps with slot diaphragm valves.

E. Hydraulic metering pump drive with partial width disconnection.

F. Optionally there is a hydraulic partial width metering pump drive.

G. An electrohydraulic flat slide pulse valve or several such pulse valves.

H. Supply forward feed and washing system for the individual active ingredients.

I. Calibrating devices and modes for establishing the liquid quantity actually delivered per pulse and metering pump.

A. Computer

The metering or active ingredient pumps are constructed in such a way that the metering pumps or their diaphragms always deliver for each feed or delivery cycle a precisely identical active ingredient quantity. If the liquid volume delivered per delivery cycle and the number of nozzles on the equipment is known as a multiplier, it is possible to precisely define the active ingredient quantity delivered by cycle (pulse). The active ingredient quantity to be delivered can consequently be calculated in accordance with the instantaneously delivered water quantity and the predetermined concentration and defined in pulses. This is made possible by the association of a precisely delivered active ingredient quantity with each pulse.

A computer with the corresponding software is able for e.g. three active ingredients and optionally even separated on the basis of partial widths, to generated the pulse frequency necessary for producing the desired concentration in accordance with the following preset values:

Desired active ingredient concentration: input=input by user.

Number of nozzles: input=input by user.

Calibrated delivery per 100 pulses in a metering pump: input=input by user.

The instantaneously applied water quantity: input=pulse frequency of pickup or flow rate meter.

For each of the active ingredients, e.g. three such ingredients and if necessary also separated for each partial width, the computer provides as the output the pulse frequency necessary for producing the required concentration. As the applied water quantity is the result of the spraying pressure, the nozzles used, the running speed and the working width of the equipment, there is no need to include such data for generating pulses for the active ingredient delivery.

B. Nozzle Holder

The nozzle holder shown in FIG. 5 is an important component of the present invention and on it there can be up to three active ingredient or metering pumps 12, 14. One of the metering pumps 14 is shown in section in FIG. 5, whereas only part of the further metering pump 12 can be seen. The nozzle holder 10 also has a mixing chamber 16 and a hydraulic diaphragm valve 18 for opening a liquid supply to a spraying nozzle 20. In the rest or inoperative position the diaphragm valve 18 is closed by a cone 24 by means of the pressure of a spring 22. Pressure acts on a diaphragm 28 of diaphragm valve 18 via a hydraulic connection 26. If there is a defined overpressure at diaphragm 28, it forces the cone 24 out of its seat and frees a flow connection to the spraying nozzle 20. The spraying nozzle 20 is fixed to the nozzle holder 10 by a box nut 21.

As shown in FIG. 5, the metering pumps 12, 14 are fixed to the right side of nozzle holder 10 and to the rear side. A further metering pump can be positioned on the front side of the nozzle holder 10 not visible in FIG. 5. The nozzle holder 10 has infeed openings 30, 32 through which active ingredient passes by means of metering pumps 12, 14 into a water flow of a carrier liquid line 34 to which is fixed nozzle holder 10 and with which it is in flow connection. So that the infeed openings 30, 32, relative to the water flow, are in an almost identical position or at approximately the same height, the front metering pump not visible in FIG. 5 the right-hand metering pump 14 in FIG. 5 and the rear metering pump 12 in FIG. 5 are fitted turned by 90ø.

After the active ingredients have in pulse form been delivered through infeed openings 30, 32 to the water flow, they enter mixing chamber 16. Mixing chamber 16 is constructed in such a way that the water and active ingredients pass in countercurrent manner, i.e. the inlet and outlet openings are on the same side, as can be seen in FIG. 5. The distribution and mixing of water and active ingredients is brought about by two perforated sheets 36, which are placed between the top inlet area in FIG. 5 and the bottom outlet area in FIG. 5. The holes in the perforated sheets 36 are sufficiently large for the sum of their passage to correspond roughly to the maximum flow quantity in the given use case. As a result the liquid flow is necessarily distributed over all the existing holes of the perforated sheets 36 and therefore over the entire length of mixing chamber 16. For this purpose there are the same number of holes on the top perforated sheet 36 and on the bottom perforated sheet 36 in FIG. 5. The holes of the upper perforated sheet 36 and the holes of the lower perforated sheet 36 are displaced with respect to one another.

As is apparent from FIG. 6, which shows the nozzle holder 10 in mixing and spraying operation, this produces two effects. It firstly ensures that the liquid flows through the entire length of the mixing chamber 16 and passes downwards through the perforated sheets 36. As a result of the countercurrent in the upper section of mixing chamber 16 and also in the lower section of mixing chamber 16, there is an optimum distribution or dispersion of the active ingredients in the longitudinal direction of the feed flow. As a result of the displaced arrangement of the holes, on flowing through the perforated sheets 36 turbulence occurs and as a result there is a fine dispersion of the active ingredients in the water. FIG. 6 illustrates the carrier liquid water by means of black dots, a first active ingredient fed in through infeed opening 32 by light grey dots and a second active ingredient fed in through infeed opening 30 by dark grey dots.

As can be seen in FIG. 6, the diaphragm valve 18 just upstream of spraying nozzle 5 in the lower area of the nozzle holder is opened by the active pressure of the hydraulics connected to connecting piece 26, so that via diaphragm 28 cone 24 is raised from its seat in nozzle holder 10 and consequently liquid can reach the spraying nozzle 20.

As can be gathered from FIGS. 5 and 6, the inventive nozzle holder 10 is placed directly on support pipe 34 and has a compact construction in spite of the mixing chamber 16 and up to three metering pumps 12, 14 located directly at nozzle holder 10. The nozzle holder 10 according to the invention as a result of the integration of the mixing chamber 16 and despite the short path up to the spraying nozzle 20, permits a good mixing between the active ingredient and the carrier liquid.

C. Diaphragm Metering Pumps with Slot Diaphragm Valve

The metering pumps 14, 40 shown in FIGS. 1 to 4 are given a sandwich structure. For example, the metering pump 14 of FIG. 1 is constructed from several, appropriately designed mouldings 42, 44, 46, 48, 50 and 52, which combine the function of a casing and function openings. Between said mouldings are fixed a valve diaphragm 54 and a feed diaphragm 56, which simultaneously fulfil the sealing required. In the embodiment shown the mouldings are sealed by flat seals 58, but other seal types are possible. The mouldings are pressed together by four tie rods 60, which extend through holes in the mouldings, as can be seen e.g. in FIG. 10 and designated there by reference numeral 62.

As is shown in FIG. 1, the active ingredient is delivered by the operation of feed diaphragm 56, whose feed path is predetermined by two piercing dies in mouldings 48, 50. Through the predetermination of the position of the feed diaphragm 56 in both extreme positions, the shape change of the feed diaphragm 56 and consequently its feed capacity per stroke is precisely defined. In the inoperative state, illustrated in FIG. 4, as a result of its own elasticity and the vacuum of approximately 0.5 bar prevailing in the drive system, the feed diaphragm 56 engages on the vacuum piercing die of moulding 50. This vacuum is required for the function of the diaphragm metering pumps. The vacuum in the system when the feed diaphragm 56 is in the idle position is necessary to move the feed diaphragm 56 of the metering pumps back into the rest position shown in FIG. 4, whilst sucking in active ingredient. This is assisted by the elasticity of the diaphragm material, which is expanded for feed purposes. Therefore for the rest position a planar resting of the feed diaphragm 56 on the vacuum piercing die of the moulding 50 is used, so that in the rest position the diaphragm material structure is relaxed. Merely in order to protect the diaphragm material, a possible lenticular design of the feed chamber has not been used.

For each pressure pulse in the drive system, there is a change in the pressure potential in the drive system of metering pump 14, which is connected to hole 64, from a vacuum to an overpressure of approximately 10 bar. As a result of the overpressure the feed diaphragm 56 is pressed against the overpressure piercing die in moulding 48. This position of the feed diaphragm 56 is illustrated in FIGS. 1 to 3. Thus, each diaphragm stroke leads to the delivery of a precisely defined active ingredient quantity. As is apparent from FIGS. 3 and 4, in the idle or vacuum stroke according to FIG. 4 active ingredient is sucked from the active ingredient supply line 66 into the feed chamber of the diaphragm metering pump. The active ingredient must flow between the active ingredient supply line 66 and the feed chamber through the valve diaphragm 54. According to FIG. 4, valve diaphragm 54 in the idle or vacuum cycle closes a flow connection between the feed chamber and the outlet or infeed opening 30.

If the overpressure in drive system 64 moves the feed diaphragm 56 into the position shown in FIG. 3 in the operating or pressure cycle, the active ingredient is forced from the feed chamber through valve diaphragm 3 into the outlet or infeed opening 30. In the operating or pressure cycle a flow connection between the active ingredient supply line 66 and the feed chamber is closed by valve diaphragm 54.

Valve diaphragm 54 is shown in greater detail in FIGS. 10 to 12 and is provided at two precisely predefined positions with outlet slots 68, whereof only one can be seen in FIG. 10. The second outlet slot which is not visible in FIG. 10 is identical to the visible outlet slot 68 and in FIG. 10 is merely concealed by moulding 9. The suction and pressure valves of valve diaphragm 3 are brought about by the opposing fitting of two constructionally identical, but oppositely fitted mouldings 44, 46 in the form of perforated plates and between which is fixed the valve diaphragm 54. These mouldings or perforated plates 44, 46 are in each case provided with two valve holes, as well as with a round passage opening 72. If these three components, i.e. perforated plates 44, 46 and the interposed valve diaphragm 54 are fitted in the manner shown, this gives both the suction valve and the pressure valve in accordance with FIG. 9.

The operation of the suction valve and pressure valve are illustrated in detail in FIGS. 11 and 12. Valve diaphragm 54 conceals both the valve holes 70 of suction side 4 and the valve holes 74 of the pressure side, because the outlet slots 68 of valve diaphragm 54 are located precisely between the valve holes 70, 74. Thus, if pressure is applied to the feed diaphragm 56 in accordance with FIG. 9, the active ingredient presses from the feed chamber through the valve hole 70 on valve diaphragm 54. As shown in FIG. 12, the latter is raised and then the active ingredient, as shown in FIG. 12, can flow out at outlet or infeed opening 30. Simultaneously the pressure of the active ingredient in the feed chamber presses on valve diaphragm 54 in the vicinity of the suction valve. The valve diaphragm 54 is then pressed onto valve holes 74 and seals them according to FIG. 12.

If the feed diaphragm 56 is sucked back into its idle position, the suction valve operates according to FIG. 11, in that the valve diaphragm 54 is raised from the valve hole 74 and consequently active ingredient can flow from active ingredient supply line 66 through valve hole 74 and valve slot 68 of valve diaphragm 54 into the feed chamber. Simultaneously the valve holes 70 on the outlet side are closed by the valve diaphragm 54 being pressed against the same. For opening the valves it is necessary to have a specific minimum pressure, which is predetermined by the diaphragm material elasticity and is necessary for reliable operation. Diverging from the prior art, the function of the valves is produced solely through the arrangement and consistency or material characteristics of the valve diaphragm. Fault-prone ball valves or valve bodies or springs are avoided.

As shown in FIG. 2, in an embodiment of the metering pump, it is also possible to connect in series two or more valve diaphragms 54. This provides the option in the case of complicated media and higher pressures to improve the operational reliability and safety, reduce diaphragm loading and create redundancies.

D. Diaphragm-Sealed Reciprocating Metering Pump with Slot Diaphragm Valve

Another embodiment of the metering pump according to the invention is illustrated in the sectional views of FIGS. 21, 22, 23 and 24 and is called a diaphragm-sealed reciprocating metering pump with slot diaphragm valve. The diaphragm metering pump of FIGS. 1 to 4 admittedly has the advantage that from the construction standpoint account has been taken of the rough conditions in agriculture, the aggressive of the liquids conveyed and the large number of movement cycles and in general mechanical components have been obviated. As a result of the precise predetermination of the form of the pump diaphragm in the idle position and during feed or delivery, a change to the consistency or material characteristics of such a diaphragm, e.g. due to ageing, has no influence on the stroke or lift and consequently the delivery. This is only made possible by the specific form of the drive pulse, which changes between vacuum in the idle or rest position and overpressure during the working cycle. However, the change between these two pressure potentials takes up a certain time, which is dependent on the level of the potential difference. This potential change time is also influenced by inertia and consistency of the hydraulic fluid.

In order to permit shorter cycle times, the invention also provides a diaphragm-sealed reciprocating metering pump 80. As shown in FIG. 21, this metering pump 80 also has a sandwich structure and consequently has a similar structure to the diaphragm metering pump. The same slot diaphragm valves are used in a single design according to FIG. 21 and a double design according to FIG. 22.

Unlike in the case of the diaphragm pump a base plate 82 is provided and, in addition to its function as a casing, it constitutes an abutment for a return spring 84 and a stop for a piston 86. Through-flow openings are provided in base plate 82. Beneath a sealing diaphragm 88 is located piston 86, which is guided by guideways 90 in cylinder 92, cf. FIG. 24. Also in the case of this metering pump, in the rest position the sealing diaphragm 88 engages on a piercing die 94, but here this is caused by the pressure of piston 86 as a result of return spring 84. If there is a hydraulic pressure pulse via hydraulic connection 96, the sealing diaphragm 88 and with it the piston is moved to the left counter to the tension of return spring 84, cf. FIG. 21. In FIG. 23 piston 86 is moved downwards until it strikes against the casing stop 98. This position of piston 86 precisely presets the position of the pump diaphragm 88 during a pressure pulse. Thus, also with this diaphragm-sealed reciprocating metering pump, for each pressure pulse precisely the same delivery is provided as a result of the path of sealing diaphragm 88 being precisely predetermined by piston 86. With this metering pump piston 86 defines the position during pressure and takes over the return movement of sealing diaphragm 88 during a pressure pulse reduction, as well as the fixing of the sealing diaphragm 88 in the rest position through the pressure of return spring 84.

This makes it possible to avoid producing a vacuum in the drive system for bringing about the rest position, because the return spring 84 assumes responsibility for return and fixing. Thus, the vacuum for the suction of the liquid to be delivered is also produced by the spring pressure. This permits shorter cycle times during the production of the pressure pulses due to the avoidance of the vacuum cycle and the resulting reduction in the potential difference during each pulse.

E. Hydraulic Metering Pump Drive with Partial Width Disconnection

To convert the electric pulses produced by a control unit into hydraulic pulses for driving the metering pumps, the invention provides a separate hydraulic drive system for said metering pumps. Such a hydraulic drive system is shown in a first embodiment in FIG. 7 and in a second embodiment in FIG. 8.

The hydraulic drive system of FIG. 7 has a hydraulic fluid tank 100, a low power geared pump 102 driven together with the water pump for spraying, at least one flat slide pulse valve 104 and further fittings, which will be explained hereinafter.

In FIGS. 7 and 8 is in each case only shown the hydraulic drive system for one active ingredient. In the case of an optional use of two or three active ingredients and a corresponding number of metering pumps, the hydraulic drive system is present a number of times as from the flat slide pulse valve 104.

Unlike in the prior art, the hydraulic fluid is e.g. constituted by glucose-based brake fluid or some other suitable fluid with an identical consistency. Such hydraulic fluids ensure a rapid transmission of hydraulic pulses with limited inertia of the pressure change. The hydraulic fluid tank 100 has a size such that its volume and surface are sufficient for cooling the hydraulic fluid.

In the suction area of the geared pump 102 a vacuum valve 106 is provided in such a way that only on the application of a vacuum of approximately −0.5 to −0.7 bar predetermined by the spring pressure of vacuum valve 106 is hydraulic fluid sucked from tank 100. A pressure limiting valve 108 is provided for limiting the pressure to a value of approximately 12 to 15 bar.

To convert the electric pulses of the computer output into hydraulic pulses for driving the metering pumps use is made of the flat slide pulse valve 104, whose construction is described in detail hereinafter in section G. The flat slide pulse valve 104 produces a hydraulic pulse from an electric pulse generated by computer 109. On using diaphragm metering pumps, said pulse consists of a pressure change in the hydraulic drive system from −0.5 bar to 10 bar and then back again to −0.5 bar. When using diaphragm-sealed piston pumps the structure and function of the hydraulic drive system is the same, but as a result of a changed setting of the vacuum valve 5 during the rest cycle a lower vacuum of −0.1 bar to −0.2 bar is generated, which is admittedly no longer necessary for the function of the diaphragm-sealed reciprocating metering pumps, but assists the pressure drop in the system after the pressure cycle.

The duration of the electric pulse generated by the computer is to be determined by testing and optimized. The necessary electric pulse duration is chosen in such a way that it is possible to conclude a complete working cycle of each metering pump present, even under the least favourable conditions. It must be borne in mind that several factors negatively influence the time up to the conclusion of the feed cycle of each metering pump in the system. The most important factor is the pressure potential change phase and in particular the pressure drop phase. In addition, account must be taken of the inertia of the liquid flows, the expansion and contraction of the line material and the working life of the diaphragms.

For the disconnection of partial widths, together with the nozzles of the particular partial width it is also necessary to disconnect their metering pumps.

In the simpler hydraulic drive system embodiment illustrated in FIG. 7 all the metering pumps 14 for an active ingredient are controlled by the flat slide pulse valve 104. Therefore metering relative to detail widths is impossible.

As can be seen in FIG. 7, the flat slide pulse valve 104 corresponding to the partial widths 112, 114, 116, 118, 120 dependent on the working width is followed by the partial width valves 110, which interrupt the connection between the valve 104 and the metering pumps 14 of the associated partial width. Ideally use is made here of standard engine valves, which only consume current or power during the switching process. As can be gathered from FIG. 7, this makes it possible to separately connect in or disconnect the drive for each individual partial width 112, 114, 116, 118, 120.

F. Hydraulic Partial width Metering Pump Drive

In the embodiment of the hydraulic drive system shown in FIG. 8, for each partial width and for each active ingredient there is a flat slide pulse valve 104a, 104b, 104c, 104d, 104e, which consequently only drives the metering pumps 14 of an associated partial width. This results from the fact that the hydraulic pulses generated by a given flat slide pulse valve 104a, 104b, 104c, 104d, 104e are only transmitted to the metering pumps 14 of a given partial width. This variant makes it possible to produce partial width-specific concentrations of active ingredients, which opens new perspectives in connection with the partial surface-specific treatment. As can be gathered from FIG. 8, there is a disconnection of partial width in this embodiment of the hydraulic drive system by switching off the electric pulse signals applied to the flat slide pulse valves 104a, 104b, 104c, 104d, 104e, so that there is no need for separate partial width valves. For this purpose the computer 109 can separately switch off the electric pulse signal for each of the flat slide pulse valves 104a, 104b, 104c, 104d, 104e and also supply a different pulse signal to each of said valves 104.

G. Electrohydraulic Flat Slide Pulse Valve

FIGS. 13, 14, 15 and 16 show the electrohydraulic flat slide pulse valve 104 according to the invention, which is necessary to permit short switching times and, independently of the pressure or vacuum to be switched, offers the lowest possible mechanical resistance. The aim is to use relatively small pull magnets with a relatively low power consumption, because in the case of a full, optional equipping up to 15 flat slide pulse valves 104 have to be simultaneously controlled. The electric power required is an important factor.

The electrohydraulic flat slide pulse valve 104 according to FIGS. 13 to 16 has a plastic casing 122. Said plastic casing 122 contains a metallic flat slide valve 124 in such a way that it can easily move between two metal plates 126 cast in the casing. The flat slide valve 124 is ground in the metal plates 126 and provides a sealing action as a result of its fit. The leaks which occur are unimportant for the function of the system. A return spring 128 is provided for resetting the flat slide valve 124. The flat slide valve 124 covers or opens two openings, a vacuum opening 130 for the vacuum and an overpressure opening 132 for the overpressure. For this purpose the flat slide valve 124 is provided with a rectangular passage opening 125 positioned in such a way that in the rest position of the flat slide valve 124, which is shown in FIG. 14, it is aligned with the vacuum opening 130 in casing 122. The overpressure connection 134 and the vacuum connection 136 are located on one side of the casing 122 and the connection 138 for the pulse lines leading to the metering pumps is located on the other side of the casing 122 or the flat slide valve 124, cf. FIG. 16.

In the rest position of the flat slide valve 124 shown in FIG. 14 the vacuum opening 130 is opened. In the system there is a vacuum of differing magnitude, which is dependent on the metering pumps used. If there is an electric pulse from the control unit computer, an actual operating current obviously being generated by external wiring, a pull magnet 140 attracts a magnet core 142, so that a flat slide valve 124 in FIG. 14 is drawn upwards. Therefore the overpressure opening 132 is opened and the vacuum opening 130 closed, as shown in FIG. 15.

At the end of the pulse, whose optimum time duration must be determined by testing, return spring 128 resets the flat slide valve 124 and consequently overpressure opening 132 is closed and vacuum opening 130 opened again, because now according to FIG. 14 passage opening 125 in flat slide valve 124 is aligned with vacuum opening 130 in casing 122.

H. Supply, Forward Feed and Washing System for Individual Active Ingredients

The diagrammatic view of FIG. 17 shows an active ingredient supply system according to a preferred embodiment of the invention. The active ingredient supply system has an active ingredient storage tank 156 and emanating therefrom active ingredient supply lines 152a, 152b, 152c, 152d, 152e, 152f and 152g leading to the individual partial widths with in each case several metering pumps 14. The metering pumps 14 of each partial width are located on a given support pipe 154a, 154b, 154c, 154d, 154e, 154f and 154g. The support pipes supply water to not shown nozzle holders and spraying nozzles. So as not to overburden representation, a water supply system is not shown in FIG. 17. By means of the active ingredient supply system shown, it is possible prior to the start of spraying to deliver active ingredient directly to the metering pumps, so that at the start of spraying there is only a negligible time lag before the correct, preset active ingredient concentration is obtained at the spraying nozzles. It is also possible with the active ingredient supply system shown to return the active ingredient in the supply lines to the active ingredient storage tank 156 at the end of spraying.

In the preferred embodiment, the active ingredients are located in the rear area of a field sprayer above the not shown water tank, so that unnecessary vacuum does not occur during suction. The active ingredient supply tank 156 can be constituted by the barrels used by the chemical suppliers or also system-optimized tanks. The supply, forward feed and washing system, which is also known as the fill and refill system or active ingredient supply system, is provided once for each different active ingredient. Thus, with three different active ingredients, there would be three of the systems shown in FIG. 17. The active ingredient system of FIG. 17 ensures that at the start of spraying the active ingredient is directly in stock in the metering pumps 14. With this system active ingredients present in supply lines 150 can be fed back to the active ingredient storage tank 156 at the end of spraying. As subsequently it is only necessary to wash out and discharge active ingredient residues adhering to the inner walls of lines, the necessary costs and therefore the necessary washing water quantity are significantly reduced.

A forward and return feed of the active ingredient is brought about by compressed air. For this purpose a small compressor 158 is driven together with the not shown water pump and the also not shown geared pump for the hydraulic drive system. An overpressure valve 160 controls the overpressure and a vacuum valve 162 in the suction area the vacuum in said pneumatic system. The optimum overpressure and vacuum values must be determined by testing. An overpressure tank 164 and a vacuum tank 166 hold the compressed air volumes required for filling and emptying.

Metering pumps 14 are supplied groupwise via active ingredient lines 150 and are connected successively and in line to in each case one active ingredient supply line 150a, 150b, 150c, 150d, 150e, 150f, 150g and the active ingredient flows through the metering pumps 14 of a group or a partial width in succession through the supply openings. These supply openings carry reference numeral 66 in FIGS. 1 and 21. At the end of each metering pump group, e.g. corresponding to a partial width, a float valve 168 is provided behind the final metering pump 14.

Float valve 168 is shown in greater detail in FIG. 18. As can be seen in FIG. 18, the float valve 168 has a casing 170 containing a float 172, which is mounted at its top and bottom by means of a guide shaft 174 in the casing 170. Thus, the float 172 is longitudinally displaceably mounted within the casing 170 and moves upwards and downwards according to FIG. 18. A valve comprising taper seat 176 at a passage opening in the casing and a valve body 178 located on guide shaft 174 above float 172 ensures that no active ingredient can enter the compressed air connection 180 and consequently the pipes of the compressed air system. An active ingredient supply line 150 is correspondingly connected to the connecting piece 182 and the compressed air system to the connecting piece 180. A pickup 184 indicates when the float 172 is in its upper end position and consequently the float chamber in the casing is filled with active ingredient. Conversely, the pickup 184 makes it possible to detect when the float 172 has dropped into the position shown in FIG. 18.

The function of the active ingredient system will now be explained relative to FIG. 17. Prior to the start of spraying the user places a suction lance 186 in the active ingredient-filled barrel 156. The suction lance 186 is illustrated in detail in FIGS. 19 and 20. A calibrating valve 188 constructed as a multiway valve is set to passage and a rinsing valve 190 at the foot of lance 186 located in active ingredient tank 156 is set to active ingredient suction. Through the operation of a pushbutton the user starts forward feed. The electropneumatic switching or control valve 192 is consequently opened and as a result of the vacuum of approximately 0.5 bar which then occurs at the end of the active ingredient supply lines 150 of the individual partial width the active ingredient is sucked out of the active ingredient tank 156, via a collecting piece 194 and through the metering pumps 14 of each group or partial width. When the active ingredient reaches the end of this supply line and arrives at the given float valve 168, it raises the float 172 of the latter and consequently seals the end of line 150 with respect to the vacuum still assisting the closing of the valve. Consequently the float valve 168 seals with the vacuum. The electronic pickup 184 at each float valve 168 indicates to the user when the valve is closed and consequently the given metering pump group has been supplied with active ingredient. The user can now release the pushbutton, so that the electropneumatic control valve 192 is closed again. As the float chamber of float valve 168 is now filled with active ingredient, the float valve 168 remains closed during the following spraying operation.

When the spraying operation is ended, the computer 109 of the control unit provides a cleaning program, which automatically initiates and controls the processes described hereinafter.

Following the start of the cleaning program by the user, the electropneumatic control valve 196 is opened, so that the compressed air tank 164 is linked with the float valves 168. For a time precisely determined by testing compressed air is passed into the system, so that the float valves 168 are pressed upwards, sealing against pressure in the case of compressed air and the active ingredients in metering pumps 14 and in the pipe system are forced back into the active ingredient storage tank 156. As the active ingredients have been removed at the top from the active ingredient storage tank 156, it is not possible for there to be a return flow after emptying lines 150.

The electropneumatic control valve 192 then closes again and the washing or rinsing valve 190 at the foot of suction lance 186 is reversed, so that water instead of active ingredient is now sucked. This is brought about in that the suction lance 186 has a conduit 198 leading to the water tank and a conduit 200 leading to the active ingredient lines 150, which can be interconnected by the rinsing valve 190. The connection with the water tank is illustrated the letter R in FIG. 17. The reversal of the rinsing valve 190 is explained in greater detail relative to FIGS. 19 and 20.

The electropneumatic control valve 192 then opens and through the vacuum applied at float valves 168 the supply lines 150 are filled with water through metering pumps 14 up to the float valves 168.

If the pickup at float valves 168 of control unit 109 indicate that the process is concluded, the user carries out a washing run during which water is delivered by metering pumps 14. Through the filling with water of active ingredient lines 150, any active ingredient residue still adhering to the inner walls thereof are diluted and can consequently be safely metered to the spray water.

For this purpose control unit 109 generates the highest technically possible number of pulses for the metering pumps 14, so as to deliver in the shortest time the maximum amount of washing and rinsing water. No risks are inherent in this procedure, because the washing mixture delivered is already diluted.

The suction lance 186 to be introduced into the active ingredient storage tank 156 is shown in detail in FIGS. 19 and 20. By means of the suction lance 186, the entire active ingredient system can be washed as from the entry into lance 186. The active ingredient is sucked via suction opening 202. A suction pipe 204 is provided as an inner pipe in an outer pipe 206. Between inner pipe 204 and outer pipe 206 there is water, which is supplied by a connection 208 connected to the water tank. The active ingredient is subject to suction action by means of suction slots 210 at the lower end of suction pipe 204.

Through the in any case operated and already described hydraulic system, it is possible by means of a pressure connection 212 to bring pressure to a piston 214 with the aim of so displacing suction pipe 204 relative to outer pipe 206 that the suction slots 210 move upwards, so that the active ingredient is partitioned off and in place of active ingredient water is sucked out of the outer pipe 206. This washing position of suction lance 186 is shown in FIG. 20. A return spring 216 reverses this procedure on disconnecting the pressure and ensures a reversal, so that active ingredient can be sucked in again.

Correspondingly the position for the suction of active ingredient is shown in FIG. 19 and the washing position of the suction lance in FIG. 20.

I. Calibrating Modes for Establishing the Liquid Quantity Actually Delivered Per Pulse and Metering Pump

The delivered liquid quantity per pulse and metering pump is a decisive quantity for the invention. For determining this quantity or for the calibration thereof, a calibrating valve 188 is provided in the supply, forward feed and washing system according to FIG. 17. By means of said calibrating valve 188 the suction lines 150 of the metering pumps 14 behind connecting piece 194 can be switched over to a measuring or graduating cylinder 220. During a calibrating operation in a first mode, this measuring cylinder 20 is filled with water up to a calibrating mark. Then the user starts in the control unit computer “calibrating mode 1”. In calibrating mode 1 the computer 109 supplies precisely 100 pulses to the metering pumps 14. The sucked in water is delivered by the metering pumps 14 into the nozzle pipes, because the actual nozzles are closed. The sucked in liquid quantity can then be read off on the measuring cylinder 220 and inputted into the computer. The computer 109 then calculates the necessary value using its known nozzle number as the divisor.

In the case of chemicals with a consistency differing significantly from water, it is possible to carry out a calibrating run using a second calibrating mode, known as “calibrating mode 2”. For this purpose a short distance is normally sprayed with the aim of ensuring a correct filling and function of all the metering pumps 14. The calibrating valve 188 is then reversed and active ingredient is filled in measuring cylinder 220. The user then starts calibrating mode 2 in computer 109. During a calibrating run the user then sprays in normal manner a distance of about 50 metres. The computer 109 then counts the pulses transmitted during this distance to the metering pumps 14. At the end of the calibrating run the user inputs into the computer 109 the quantity delivered from the measuring cylinder 220. Computer 109 is now able to determine the necessary value using the counted pulses and the number of metering pumps 14 as the divisor.

Thus, using the sprayer according to the invention it is possible, directly at the nozzle holders, to meter the active ingredients to the carrier medium, generally water. The sprayer storage tank only carries clean water. An exception is formed by the still possible application of liquid fertilizers and salts. For this purpose hydraulically driven active ingredient or metering pumps supply the water with the active ingredients and in a mixing ratio predetermined by the user, directly at each nozzle holder of a field sprayer. The active ingredient quantity to be fed in is defined in pulses on the basis of the instantaneously applied water quantity and the predetermined mixing ratio. At each nozzle holder are provided metering pumps which, per working stroke, have a precisely defined delivery. It is e.g. possible to use diaphragm pumps, the position of the diaphragm in the case of pressure and vacuum being precisely predetermined by a pressure and a vacuum die. According to the invention diaphragms or pistons of active ingredient or metering pumps are moved and therefore driven at the nozzle holders by hydraulic pressure and optionally vacuum. An independent hydraulic drive system is provided for all the system metering pumps and is able to produce a pressure potential difference, e.g. overpressure and vacuum, and uses as the hydraulic fluid a glucose-based brake fluid or some other fluid with the same consistency. In the electrohydraulic drive system an electric pulse signal is converted by an electrohydraulic pulse valve into hydraulic pulses of a hydraulic fluid. The electrohydraulic pulse valve e.g. in the rest position can supply a vacuum to the diaphragm of the metering pumps and also supply an exactly defined pressure pulse. The electrohydraulic pulse valve can have a flat slide valve sealed by a fit between two metal plates. A disconnection of individual metering pumps, e.g. the metering pump of a partial width, can be brought about in that together with the nozzles of a partial width, the metering pumps of the partial width are disconnected by interrupting the hydraulic drive. It is alternatively possible to provide for each partial width a separate electrohydraulic pulse valve, so that then different concentrations can be generated in part width-specific manner. In this case the individual partial widths are disconnected through the interruption of the electrical and therefore hydraulic pulses. There can be up to three metering pumps for each nozzle holder delivering in feed pulses in a mixing chamber belonging to each nozzle holder. Water and active ingredient pass in countercurrent manner in the mixing chamber in that the inlet and outlet openings of said chamber are on the same side. Several perforated sheets with a predefined hole size are present between the inlet and outlet openings in the mixing chamber. As a result the liquid is forced to flow through the full length of the mixing chamber and over the entire length to flow into the perforated sheets. This brings about a mixing in the longitudinal direction of the liquid flow and a forced turbulence on the path through the perforated sheets.

The valves are constituted by diaphragms made from rubber or a similar elastic material and which contains eccentric, slot-shaped openings. Passage openings in the valve casing are spaced from said slot-like openings, so that the diaphragms cover said openings in the rest state. Through a build-up or feed pressure on these holes the diaphragm can be raised and the liquid can flow through the slot-like opening. In the opposite direction the diaphragm is pressed onto the holes and reliably closes them. The pressure of the sealing diaphragm material on the valve opening to be closed does not take place by springs, but instead through the consistency of the material and the specific arrangement of the slot-like opening and valve holes.

According to the invention there is also a pneumatic active ingredient management system, which utilizes a pneumatic overpressure to bring about in the case of a field sprayer a return to the barrel of the active ingredients contained in the active ingredient line system. A pneumatic vacuum can be used for this purpose of the forward feeding of active ingredients to the metering pumps. Thus, the invention also relates to a pneumatic system for the forward or return feed or delivery of active ingredient in a sprayer. The pneumatic system vacuum against the active ingredient lines can be partitioned off by float valves, the end of forward or return feed being determined electronically or electrically and transmitted to the control unit.

For removing ingredients from the active ingredient barrels a suction lance is provided and permits directly at the foot of the lance a changeover to a washing function. The lance changeover can take place electrically or hydraulically.

Through a calibrating mode the liquid quantity actually delivered per pulse and metering pump can be determined. For this purpose during calibration operation and in the suction area active ingredients are removed from a measuring cylinder in order to determine the delivered volume. The control unit then delivers in calibration operation e.g. precisely 100 delivery pulses for the metering pumps. The delivered liquid quantity can be read off the measuring cylinder and from the delivered liquid quantity, the number of nozzles or number of metering pumps as a divisor the delivery per pulse and metering pump can be established.

A calibration can also take place through a calibration run. The calibration process can also be performed with active ingredient. On spraying a given distance, in the case of a calibration run the active ingredients are removed from a measuring cylinder in the suction area of the metering pumps and during the calibration run the control unit counts the pulses transmitted to the metering pumps. From the delivered active ingredient quantity, e.g. read from the measuring cylinder, the determined number of pulses and the number of metering pumps as the divisor, it is possible to calculate the active ingredient quantity delivered per pulse and metering pump.

For reducing the cycle times a diaphragm-sealed reciprocating metering pump is proposed. In the case of such a reciprocating metering pump the path of a diaphragm is on the one hand precisely limited by a rest position die and on the other by a piston. Driven by hydraulic pressure, the diaphragm moves the piston up to a fixed stop. The piston position in this state defines the precise position of the diaphragm. If the hydraulic pressure is reduced, a spring under the piston presses the latter and therefore the diaphragm against the rest position die. This leads to the precise rest position of the diaphragm. For each hydraulic drive pulse, such a metering pump always delivers an identical delivered quantity and only a pressure potential, but no vacuum is required for driving this metering pump.

1. Sprayer for spraying liquids, particularly for agricultural purposes, with a carrier liquid tank, a carrier liquid pump, several spraying nozzles and associated nozzle holders for connecting the spraying nozzles to a carrier liquid line, at least one active ingredient tank and several metering pumps for delivering active ingredients connectable to the active ingredient tank, characterized in that with each nozzle holder is associated at least one metering pump, which is in flow connection with the nozzle holder.

2. Sprayer according to claim 1, characterized in that there is at least one metering pump on each nozzle holder.

3. Sprayer according to claim 1, characterized in that there is a mixing chamber on each nozzle holder.

4. Sprayer according to claim 1, characterized in that a control unit is provided, which calculates the active ingredient quantity to be metered in control pulses, the metering pumps having a clearly defined delivery for each working stroke and can be driven corresponding to the control pulses.

5. Sprayer according to claim 4, characterized in that the control unit determines the number of control pulses as a function of a predetermined set value for an active substance concentration and a carrier liquid quantity instantaneously delivered by the carrier liquid pump.

6. Sprayer according to claim 4, characterized in that the metering pumps can be driven by hydraulic pulses.

7. Sprayer for spraying liquids, having a carrier liquid tank, a carrier liquid pump, several spraying nozzles, at least one active ingredient tank and at least one metering pump connectable by at least one active ingredient supply line to the active ingredient tank, characterized in that on the active ingredient supply line is provided a compressed air connection, so that during return operation active ingredient can be forced back into the active ingredient tank.

8. Sprayer according to claim 7, characterized in that several nozzle holders with metering pumps are connected in series to the active ingredient supply line and the compressed air connection is provided downstream of the final metering pump in the active ingredient supply direction.

9. Sprayer according to claim 8, characterized in that several nozzle holders are arranged in several partial widths and with each partial width is associated a partial width active ingredient supply line with in each case one compressed air connection.

10. Nozzle holder for a sprayer according to claim 7, characterized by a mixing chamber.

11. Nozzle holder for a sprayer according to claim 7, characterized by at least one metering pump.
